(19) United States
(12) Patent Application Publication
(10) Pub. No.: US 2025/0342153 A1
(43) Pub. Date: Nov. 6, 2025

(54) Systems and Methods for Chatting with a Database via LLMs Using Subject Area Driven Context Prompts

(71) Applicant: Tingkai Liu, Lisle, IL (US)

(72) Inventor: Tingkai Liu, Lisle, IL (US)

(21) Appl. No.: 19/268,768

(22) Filed: Jul. 14, 2025

(51) Int. Cl. G06F 16/2452; G06F 16/2455; G06F 40/30; H04L 51/02

(52) U.S. Cl. CPC G06F 16/24522; G06F 16/2455; G06F 40/30; H04L 51/02

(57) ABSTRACT

A system and method for enabling non-technical users to interact with a database using natural language via large language models (LLMs). The invention introduces subject-area-driven context prompts to improve the accuracy and reliability of SQL generation. A subject area is a group of selective tables/views with selective data fields which is semantically defined for business domain (e.g., Sales, HR). Each subject area has a unique context prompt that includes a focus schema, frequently used dimensional values, example queries and instructions. The system includes a chatbot server, LLM server, and database server, forming a conversational loop that eliminates the need for schema discovery at runtime and enables scalable, modular deployment across business domains.

### FIELD OF THE INVENTION

This invention relates generally to database query generation and natural language interfaces, and more specifically to systems and methods using LLMs to dynamically generate SQL queries from user input based on subject-area-driven context prompts and modular schema abstraction.

### BACKGROUND OF THE INVENTION

Non-technical users often struggle to retrieve specific information from structured databases due to the complexity of SQL and unfamiliarity with database schemas. While LLMs show promise in generating SQL from natural language, they often fail when applied to real-world, large-scale databases containing thousands of tables and fields. A primary challenge lies in guiding the LLM to understand which tables and fields are relevant to a specific user query. Other known challenges include schema ambiguity, inefficient prompt token usage, and hallucination in LLM-generated SQL results.

### SUMMARY OF THE INVENTION

The present invention addresses these limitations by introducing a system and method for interacting with databases via LLMs using subject-area-based contextual prompts. Each subject area is associated with:
A focused version of the schema (selective views/tables)
A list of frequently used attribute values
Inline metadata comments such as field meanings and acronyms
Example SQL queries and corresponding natural language instructions
   The system components include:
1. Chatbot Server—Manages user interaction, identifies subject areas, and routes requests.
2. LLM Server—Receives context+question and generates SQL; then receives SQL result+original question and generates a natural language answer.
3. Database Server—Executes SQL queries and returns data in structured format. The system enables natural language querying by combining schema-focused prompts with few-shot learning to generate accurate SQL without requiring runtime schema discovery. Its two-phase prompt design—one for SQL generation and another for answer synthesis-further minimizes hallucination risk and enhances traceability. By partitioning a large database into subject areas, the system supports modular deployment and scalability across diverse business domains.

### BRIEF DESCRIPTION OF THE DRAWINGS

(To be included as figures if submitted later. These can be added upon request.)

FIG. 1—System architecture showing chatbot, LLM, and database components.

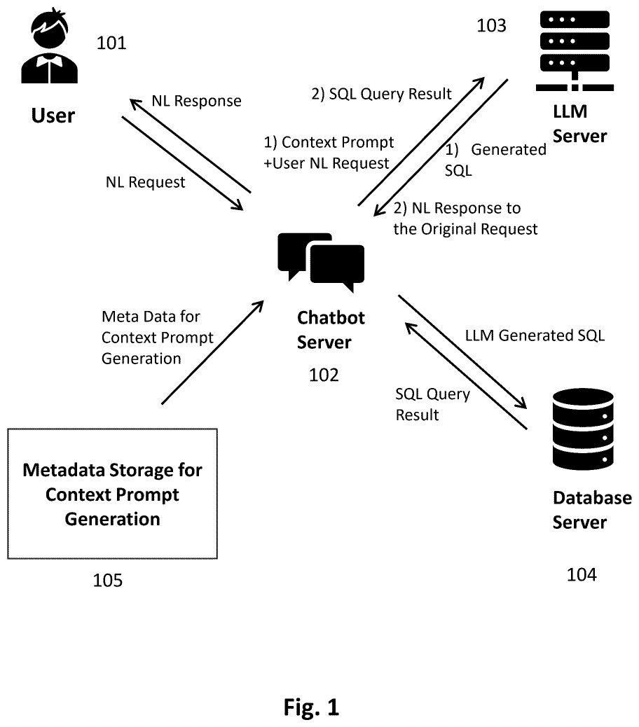

FIG. 2—Flowchart of the SQL generation and answer loop.

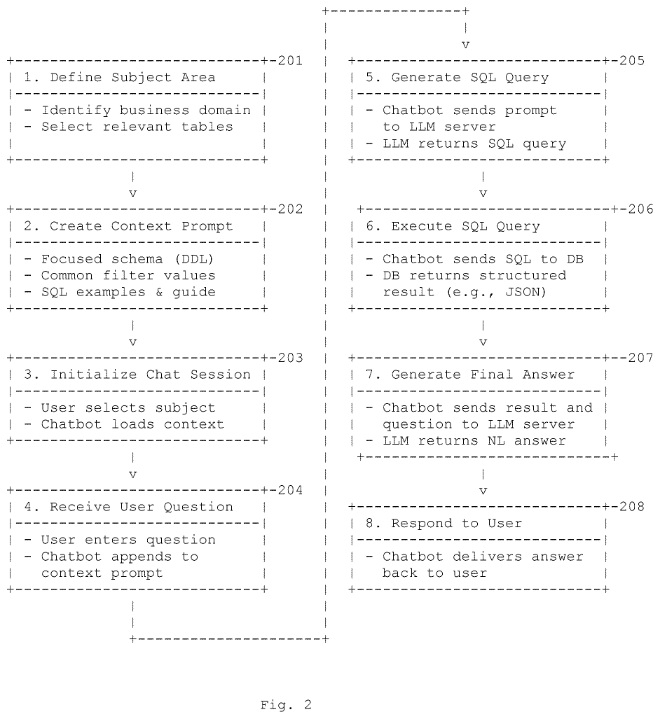

### DETAILED DESCRIPTION OF THE INVENTION

### Glossaries:

A Large Language Model (LLM) is a type of artificial intelligence model that is trained on vast amounts of text data to understand and generate human-like language.

A subject area is a group of selective tables/views with selective data fields which is semantically defined for business domain (e.g., Sales, HR).

DDL stands for Data Definition Language—it's a subset of SQL (Structured Query Language) used to define and manage the structure of database objects, such as tables, indexes, schemas, and constraints.

### System Components:

### 1. Chatbot Server

The chatbot server manages the overall conversational workflow and is configured to:
Receive a natural language input from the user via a chat interface;
Identify the relevant subject area associated with the query (e.g., Sales, HR, Finance) or based on user's role;
Generate a context prompt for the identified subject area, the context prompt comprising:
   A focused schema, representing a subset of tables or conceptual tables and fields relevant to the subject area where views are treated as conceptual tables;
   A list of frequently used attribute values annotated with business-specific terms, synonyms, and acronyms;
   Few-shot learning examples, consisting of sample natural language questions paired with example SQL queries;
   Instructions for guiding the LLM to avoid hallucination, apply correct filters, and interpret acronyms or domain-specific terms;
Append the user's natural language input to the context prompt to form a complete prompt;
Transmit the full prompt to the LLM server for SQL generation;
Receive the generated SQL, send it to the database server, and retrieve the query result;
Construct a second prompt that includes the query result, and forward it to the LLM server for final answer generation;
Deliver the natural language answer back to the user.
   By owning the context prompt generation, the chatbot server enables scalable, modular deployment across subject areas while reducing LLM token overhead.

### 2. LLM Server

The LLM server hosts one or more large language models and is configured to:
Accept prompts from the chatbot server;
Generate an appropriate SQL query based on the user query, and the schema, examples and natural language instructions in the context prompt;
Accept a second prompt comprising the SQL results, and return a corresponding natural language answer;
Follow embedded instructions to avoid hallucinating data or schema elements, and to ensure the output reflects only actual database content.

The LLM server serves as the intelligence layer of the system, converting user intent into executable SQL and synthesized responses.

### 3. Database Server

The database server is a standard relational database management system (RDBMS) that:
Receives and executes the SQL query produced by the LLM server and forwarded by the chatbot server;
Operates on the actual business data corresponding to the focused schema of the subject area;
Returns the query results in a structured format (e.g., JSON) to the chatbot server for response synthesis.

The schema used for query execution aligns with the context prompt, ensuring that the LLM-generated SQL is compatible with the underlying data structure.

### 4. Metadata Storage

Additionally, metadata for context prompt generation may be storage separately on a file location or computer server, which is beneficial for large scale deployment.

### Method Steps

1. Define Subject Area
   Identify a business-relevant subject area (e.g., Sales), consisting of a focused subset of the overall database schema relevant to a specific business domain.
2. Create Context Prompt, including:
   a. Focused Schema: Define a selective schema using SQL SELECT examples, and convert them into CREATE TABLE DDLs to include only relevant tables and columns.
   b. Attribute-Value Mapping: Curate frequently used dimensional values with inline comments to help the LLM map natural language terms to correct filter conditions.
   c. Instructions and Guidelines: Provide LLM-specific instructions such as how to handle acronyms, avoid hallucinations, and apply filters.
   d. Few-Shot Examples: Embed sample natural language questions and corresponding SQL to guide LLM behavior through in-context learning.
3. Initialize Chat Session
   A user selects a subject area via the chatbot interface. The chatbot loads the associated context prompt in preparation for receiving the user's query.
4. User Input and Prompt Assembly
   a. The user submits a natural language question via the chatbot interface.
   b. The chatbot server identifies the active subject area and loads its associated context prompt.
   c. The chatbot appends the user's question to the context prompt to form a complete input.
   d. The combined prompt is submitted to the LLM server through an API call.
5. SQL Query Generation
   a. The LLM server receives the complete prompt and generates a SQL query based on the focused schema and example logic defined in the prompt.
   b. The generated SQL is returned to the chatbot server.
6. SQL Query Execution
   a. The chatbot server extracts the SQL query and sends it to the database server.
   b. The database server executes the SQL against the relevant tables and returns the result in a structured format (e.g., JSON).
   c. The chatbot server receives and stores the query result.
7. Answer Synthesis
   a. The chatbot constructs a new prompt containing the original user question and the structured query result.
   b. This prompt is sent to the LLM server to generate a natural language answer based on the actual data returned from the database.
8. Response Delivery
   a. The LLM server returns the final human-readable answer.
   b. The chatbot server presents this answer to the user, completing the conversational query loop.

### Example Use Case:

Assume that we have a data warehouse with many subject areas. One of them is Sales.

Step 1. Define a subject area for Sales.

The Sales subject area includes the following tables:
a. sales_fact—Fact table for sales transactions
b. cust—Customer dimension
c. prod—Product dimension
d. ordr_item—Order line items
e. revw—Product reviews
f. employee—Salesperson info (shared with HR)

Step 2. Create a context prompt for the Sales subject area.

Step 2a. Create a focused version of schemas. Use SELECT statements to list all the required data fields, and add appropriate inline comments to help the LLM understand the business context and relationships between tables. Ask the LLM to convert the SELECT statements into CREATE TABLE DDLs. Review and edit the DDLs, adding primary keys and foreign keys as needed.

Reusable prompt:
You are a database administrator (DBA) assisting with schema design. I will provide a list of SELECT statements. Your task is to reverse-engineer them into CREATE TABLE statements compatible with PostgreSQL.
Please follow these instructions:
   Preserve all column names exactly as they appear.
   Infer data types from comments when available; otherwise, make reasonable assumptions.
   Include appropriate PRIMARY KEY and FOREIGN KEY constraints based on column names and context.
   Include all the comments I have in the select statement.
Here is my SQL:

-- SELECT from sales_fact (Fact Table)
SELECT

| | |
|---|---|
| fact_id, | -- PRIMARY KEY: fact_id |
| oid, | -- order_id |
| cid, | -- FOREIGN KEY: customer_id → cust (cid) |
| dt, | -- order_date |
| amt, | -- total_amount |
| sp_id | -- FOREIGN KEY: salesperson_id → employee (emp_id) |

FROM sales_fact;

| -- SELECT from cust (Customer Dimension) | |
|---|---|
| SELECT | |
| cid, | -- PRIMARY KEY: customer_id |
| fn, | -- first_name |
| ln, | -- last_name |
| em, | -- email |
| ct, | -- city |
| rg | -- region |

FROM cust;

| -- SELECT from prod (Product Dimension) | |
|---|---|
| SELECT | |
| pid, | -- PRIMARY KEY: product_id |
| pn, | -- product_name |
| cat, | -- category |
| pr | -- price |

FROM prod;

| -- SELECT from ordr_item (Order Line Items) | |
|---|---|
| SELECT | |
| oid, | -- FOREIGN KEY: order_id → sales_fact (oid) |
| pid, | -- FOREIGN KEY: product_id → prod (pid) |
| qty, | -- quantity |
| pr | -- unit_price |

FROM ordr_item;

| -- SELECT from revw (Product Reviews) | |
|---|---|
| SELECT | |
| rid, | -- PRIMARY KEY: review_id |
| pid, | -- FOREIGN KEY: product_id → prod (pid) |
| cid, | -- FOREIGN KEY: customer_id → cust (cid) |
| rt, | -- rating (1 to 5) |
| cm, | -- comment |
| dt | -- review_date |

FROM revw;

-- SELECT from employee (Shared Dimension: Salesperson Info)
SELECT

| | |
|---|---|
| emp_id, | -- PRIMARY KEY: employee_id |
| first_name, | -- first_name |
| last_name, | -- last_name |
| email, | -- email |
| phone_number, | -- phone_number |
| hire_date | -- hire_date |

FROM employee;

Using this prompt, LLM produces table definitions that can be used in the context prompt after review.

Step 2b. Include a list of commonly used values for each key dimension in a SELECT statement with inline comments.

For example, the following query gives the LLM context to understand that when a user mentions “Nutrition,” it maps to cat IN (‘Supplements & Vitamins’).

```
SELECT count (1) FROM prod WHERE cat IN (
  ‘Electronics',
  ‘Footwear’,
  ‘Eyewear’, -- Glasses
  ‘Fitness',
  ‘Cosmetics', -- Makeup
  ‘Supplements & Vitamins' -- Nutrition
);
```

Step 2c. Add instructions to form a context prompt.

Context prompt for Sales subject area:
You are a SQL assistant that helps generate correct and optimized SQL queries based on natural language questions. Use the standard SQL style that should be compatible with PostgreSQL.
The database schema is as follows:

-- Fact Table: sales_fact
CREATE TABLE sales_fact (

| | |
|---|---|
| fact_id INT PRIMARY KEY, | -- fact_id |
| oid INT, | -- order_id |
| cid INT, | -- customer_id |
| dt DATE, | -- order_date |
| amt DECIMAL (10, 2), | -- total_amount |
| sp_id INT, | -- salesperson_id (derived from |

```
employee_id)
  FOREIGN KEY (cid)
  REFERENCES cust (cid) ,
```

| | |
|---|---|
| FOREIGN KEY (sp_id) | -- Reference to employee |
| REFERENCES employee (emp_id) | |

table
);

| -- Dimension Table: cust | |
|---|---|
| CREATE TABLE cust ( | |
| cid INT PRIMARY KEY, | -- customer_id |
| fn VARCHAR (50), | -- first_name |
| ln VARCHAR (50), | -- last_name |
| em VARCHAR (100), | -- email |
| ct VARCHAR (50), | -- city |
| rg VARCHAR (50) | -- region |

);

| -- Dimension Table: prod | |
|---|---|
| CREATE TABLE prod ( | |
| pid INT PRIMARY KEY, | -- product_id |
| pn VARCHAR (100), | -- product_name |
| cat VARCHAR (50), | -- category |
| pr DECIMAL (10, 2) | -- price |
| ); | |

| -- Dimension Table: ordr_item | |
|---|---|
| CREATE TABLE ordr_item ( | |
| oid INT, | -- order_id |
| pid INT, | -- product_id |
| qty INT, | -- quantity |
| pr DECIMAL (10, 2), | -- unit_price |

```
  FOREIGN KEY (oid) REFERENCES sales_fact (oid) ,
  FOREIGN KEY (pid) REFERENCES prod (pid)
);
```

| -- Dimension Table: revw | |
|---|---|
| CREATE TABLE revw ( | |
| rid INT PRIMARY KEY, | -- review_id |
| pid INT, | -- product_id |
| cid INT, | -- customer_id |
| rt INT, | -- rating (1 to 5) |
| cm TEXT, | -- comment |
| dt DATE, | -- review_date |

```
  FOREIGN KEY (pid) REFERENCES prod (pid) ,
  FOREIGN KEY (cid) REFERENCES cust (cid)
);
```

| -- Dimension Table: employee | |
|---|---|
| CREATE TABLE employee ( | |
| emp_id INT PRIMARY KEY, | -- employee_id |
| first_name VARCHAR (50), | -- first_name |
| last_name VARCHAR (50), | -- last_name |
| email VARCHAR (100), | -- email |
| phone_number VARCHAR (15), | -- phone_number |
| hire_date DATE | -- hire_date |

);

Here are sample examples of how I want to filter data of my dimensions. Whenever a dimension value is mentioned, help me automatically associate the data field to create the filter. For example, if I mention Midwest, you should know I am referring to rg IN (‘Midwest’).
Filter 1: the cities of customer.

```
SELECT count (1) FROM cust WHERE ct IN (
  ‘Chicago’,
  ‘New York’,
  ‘Austin’,
  ‘San Francisco’
);
```

Filter 2: the regions of customer.

```
SELECT count (1) FROM cust WHERE rg IN (
  ‘Midwest’,
  ‘East’,
  ‘South’,
  ‘West’
);
```

Filter 3: the product category.

```
SELECT count (1) FROM prod WHERE cat IN (
  ‘Electronics',
  ‘Footwear’,
  ‘Eyewear’, -- Glasses
  ‘Fitness',
  ‘Cosmetics', -- Makeup
  ‘Supplements & Vitamins' -- Nutrition
);
```

Here are a few-shot examples:
Q1: Give me the top 5 customers who buy the most makeup in Chicago.
A1:
SELECT
   c.cid,
   c.fn AS first_name,
   c.ln AS last_name,
   SUM(oi.qty*oi.pr) AS total_spent
FROM sales_fact sf
JOIN cust c ON sf.cid=c.cid
JOIN ordr_item oi ON sf.oid=oi.oid
JOIN prod p ON oi.pid=p.pid
WHERE c.ct=‘Chicago’
   AND p.cat=‘Cosmetics’—Makeup is interpreted based on filter comment
GROUP BY c.cid, c.fn, c.ln
ORDER BY total_spent DESC
LIMIT 5;
Q2: Show sales in West region for glasses in June.
A2:
SELECT
   SUM(oi.qty*oi.pr) AS total_sales
FROM sales_fact sf
JOIN cust c ON sf.cid=c.cid
JOIN ordr_item oi ON sf.oid=oi.oid
JOIN prod p ON oi.pid=p.pid
WHERE c.rg=‘West’
   AND p.cat=‘Eyewear’—Glasses is interpreted based on filter comment
   AND EXTRACT (MONTH FROM sf.dt)=6;
Q3: What is the sales trending by region over the past year?
A3:
SELECT
   DATE_TRUNC(‘month’, sf.dt) AS month,
   c.rg AS region,
   SUM(sf.amt) AS total_sales
FROM sales_fact sf
JOIN cust c ON sf.cid=c.cid
WHERE sf.dt>=CURRENT_DATE−INTERVAL ‘1 year’
GROUP BY month, c.rg
ORDER BY month, c.rg;
Instructions:
   When a question is asked, generate SQL for it.
   Never hallucinate SQL results.
   The SQL will be extracted to query a database and return the result as a JSON string. When you receive a JSON string, answer the question based on it.
Here is my question:

Step 3. Let's say a Sales Analyst logs into the system. They can select the Sales subject area. The chatbot will use the Sales context prompt. When the analyst asks a question, e.g., “Which product is most popular in New York?”, the chatbot appends the user's question to the context prompt to form a complete prompt, and submits it to the LLM server through an API call.

Step 4. The LLM server processes the prompt and generates SQL corresponding to the question, and returns it to the chatbot server.

Here is an example response:
SELECT
   p.pn AS product_name,
   SUM(oi.qty) AS total_quantity
FROM sales_fact sf
JOIN cust c ON sf.cid=c.cid
JOIN ordr_item oi ON sf.oid=oi.oid
JOIN prod p ON oi.pid=p.pid
WHERE c.ct=‘New York’
GROUP BY p.pn
ORDER BY total_quantity DESC
LIMIT 1;
This query:
   Filters for customers in New York.
   Joins order and product data.
   Aggregates by product name to get the total quantity sold.
   Returns the most popular product by highest quantity.

Step 5. The chatbot server extracts the SQL from the output.

Step 6. It queries the database server, which returns the result. Example result:

```
{
  “product_name”: “Apple Airpods Pro”,
  “total_quantity”: 312
}
```

Step 7. The chatbot feeds the result into a prompt and submits it to the LLM server.

Step 8. The LLM answers the question based on the result.
Example Answer:
The most popular product in New York is Apple Airpods Pro, with 312 units sold.

### Advantages:

Enables non-technical users to access complex data.
Reduces hallucination by constraining the LLM to relevant schema and filters.
Subject-area prompts are modular and reusable.
Supports scaling across departments (e.g., Sales, HR, Finance).
Improves LLM performance by reducing token count with schema focus.
Enables faster onboarding of new subject areas with reusable prompt templates.

1. A system for generating SQL queries from natural language input using large language models, comprising:
a chatbot server configured to receive a natural language input from a user and identify a subject area, and to create a specific context prompt for the subject area comprising a focused schema that contains selective tables or conceptual tables with selective columns;
an LLM server configured to receive the context prompt and natural language input and to return a SQL query;
a database server configured to execute the SQL query and return results;
wherein the LLM server further generates a natural language answer based on the results and original input.

2. The system of claim 1, wherein the focused schema is derived from SELECT statements converted into CREATE TABLE DDL.

3. The system of claim 1, wherein the context prompt includes frequently used dimensional values annotated with natural language or domain-specific terms or acronyms.

4. The system of claim 1, wherein the chatbot appends the user input to the context prompt dynamically prior to submission.

5. The system of claim 1, wherein the LLM is instructed not to hallucinate data and to await actual query results.

6. The system of claim 1, wherein each subject area has a context prompt that supports queries for the subject area.

7. The system of claim 1, wherein the response is produced using a second LLM prompt that inputs query result data.

8. A method for generating SQL queries from natural language input using a large language model, the method comprising:
a. receiving, by a chatbot server, a natural language input from a user;
b. identifying a subject area associated with the input;
c. creating, based on the subject area, a context prompt comprising a focused schema with selective tables (or conceptual tables) and selective fields;
d. appending the natural language input to the context prompt;
e. transmitting the combined prompt to an LLM server;
f. generating a SQL query using the LLM server based on the prompt;
g. executing the SQL query using a database server to obtain a query result; and
h. generating a natural language answer using the LLM server based on the query result and the original user input.

9. The method of claim 8, wherein the focused schema is derived from SELECT statements reverse-engineered into CREATE TABLE DDL format.

10. The method of claim 8, wherein the context prompt includes frequently used attribute values annotated with natural language equivalents, synonyms, or domain-specific acronyms.

11. The method of claim 8, wherein the chatbot server dynamically appends the user input to the context prompt prior to transmitting the prompt to the LLM server.

12. The method of claim 8, wherein the LLM is instructed via the context prompt to avoid hallucinated values and to base answers only on actual database query results.

13. The method of claim 8, wherein a distinct context prompt is defined for each subject area to enable modular and domain-specific natural language querying.

14. The method of claim 8, wherein generating the natural language answer comprises submitting a second prompt to the LLM server, the second prompt including the original user input and the structured query result.
